(19) United States
(12) Patent Application Publication
(10) Pub. No.: US 2021/0066798 A1
(43) Pub. Date: Mar. 4, 2021

(54) RF Lens Device for Improving Directivity of Antenna Array, and Transmitting and Receiving Antenna System Comprising Same

(71) Applicant: QUI INC., Daejeon (KR)

(72) Inventor: Byung Jae Kwak, Daejeon (KR)

(73) Assignee: QUI INC., Daejeon (KR)

(21) Appl. No.: 16/961,282

(22) PCT Filed: Jan. 11, 2018
(86) PCT No.: PCT/KR2018/000541

§ 371 Date: Aug. 7, 2020

(51) Int. Cl. H01Q 3/46

(52) U.S. Cl. CPC H01Q 3/46

(57) ABSTRACT

Disclosed are an RF lens device for improving the directivity of an antenna array, a transmitting and receiving antenna system comprising the RF lens device, and a method for performing beamforming in the transmitting and receiving antenna system. The transmitting and receiving antenna system according to an embodiment comprises: an antenna array comprising a plurality of antennas; RF lenses for the antennas, wherein the RF lenses for the antennas are disposed above the antenna array, such that each of the RF lenses corresponds to each of the plurality of antennas; and an RF lens for the array, wherein the RF lens for the array is disposed above the RF lenses for the antennas.

### TECHNICAL FIELD

Embodiments of the inventive concept described herein relate to a transmit and receive antenna system having multiple antennas, and more particularly, relate to a transmit and receive antenna system for improving directionality of an antenna array by using an RF lens.

The inventive concept has been derived from the Public technology-based Market Connection Start-up Search Support Project of the Ministry of Science, ICT and Future Planning (Project unique number: 1711047948, Government department name: the Ministry of Science, ICT and Future Planning of Korea, Research management professional institution: The National Research Foundation of Korea, Research business name: the Public technology-based Market Connection Start-up Search Support Project, Research project name: High Performance Short Range Radar for Self-Driving Cars, Contribution Ratio: 1/1, Managing institution: the Korea advanced institute for science and technology, Research period: 2016. Sep. 5˜2017. Feb. 28).

### BACKGROUND ART

A wireless communication system, a radar, or the like includes a transmit and receive antenna system which transmits and receives wireless signals. A modern transmit and receive antenna system frequently uses multiple antennas, When using the multiple-input multiple-output (MIMO) technology or the beamforming technology, a transmit and receive antenna system based on multiple antennas has many advantages of increasing a data transfer rate, reducing interference between devices, increasing a signal transmission distance, or increasing a signal-to-noise ratio.

Herein, the transmit beamforming technology is a technology of adjusting a phase and amplitude of a signal transmitted from each of multiple antennas such that a transmit signal is transmitted with directionality while signals transmitted from different antennas cause constructive interference or destructive interference depending on their directions. The receive beamforming technology is a technology of adjusting and combining a phase and amplitude of a signal received in each of multiple antennas to enhance receive sensitivity in a specific direction and receive a signal with directionality and being the same as the transmit beamforming in a basic principle. The transmit or receive beamforming is a technology applicable when a signal transmitted or received in each antenna is stochastically highly correlated.

On the other hand, unlike the beamforming technology, the MMO technology is a technology used when signals transmitted and received in each antenna are stochastically uncorrelated. The MIMO technology may transmit and receive several data streams at the same time using multiple antennas or may obtain performance robust to a change in channel environment using a diversity gain. The MIMO technology tends to be degraded in performance as a correlation between signals transmitted or received in each antenna becomes high.

Recently, research has been dynamically conducted in the above-mentioned MIMO and beamforming technologies as methods for efficiently using frequency resources depending on depletion of the frequency resources in the wireless communication field. Such MIMO and beamforming technologies are expected to be a key technology for 5G mobile communication, Furthermore, as there has been a growing interest in an advanced driver assistance system (ACAS) and self-driving cars, as it has become so competitive to develop a radar for car with better performance, multiple antennas have been gradually and fundamentally introduced into the radar for car.

Thus, embodiments below propose a technology capable of resolving MIMO and beamforming problems and improving performance, in a transmit and receive antenna system having multiple antennas.

### DETAILED DESCRIPTION OF THE INVENTION

### Technical Problem

Embodiments provide a technology capable of resolving degradation of the steering performance of the antenna array, which occurs by non-linearity between a spatial frequency and an incident angle and directionality of the antenna and covering a wide angle using a single antenna array, in a transmit and receive antenna system having multiple antennas.

In detail, embodiments provide a transmit and receive antenna system using an RF lens device including RF lenses for antenna disposed to respectively correspond to a plurality of antennas forming an antenna array and an RF lens for array provided in an upper portion of the RF lenses for antenna and a beamforming method.

### Technical Solution

According to an exemplary embodiment, a transmit and receive antenna system for improving antenna directionality may include an antenna array composed of a plurality of antennas, RF lenses for antenna provided in an upper portion of the antenna array—the RF lenses for antenna being disposed to respectively correspond to the plurality of antennas—, and an RF lens for array provided in an upper portion of the RF lenses for array.

According to an aspect, each of the RF lenses for antenna may change a beam shape of each of the plurality of antennas. The antenna array may form a beam within a first angle range. The RF lens for array may refract a steering angle of the beam of the antenna array such that a steering angle range of the beam of the antenna array is changed from the first angle range to a second angle range wider or narrower than the first angle range.

According to another aspect, the antenna array may determine the first angle range satisfying a constraint by the changed beam shape of each of the plurality of antennas.

According to another aspect, each of the RF lenses for antenna may refract rays forming a beam of each of the plurality of antennas to change the beam shape of each of the plurality of antennas within a specific angle range.

According to another aspect, each of the RF lenses for antenna may be provided to be able to control a lens focal length to adaptively adjust the specific angle range.

According to another aspect, each of the RF lenses for antenna may refract rays of each of the plurality of antennas such that a gain of each of the plurality of antennas has a threshold within only the specific angle range.

According to another aspect, the RF lenses for antenna may be disposed to respectively correspond one to one with the plurality of antennas.

According to another aspect, the RF lens for array may be provided to be able to control a lens focal length to adaptively adjust the second angle range.

According to an exemplary embodiment, an RF lens device provided in an upper portion of an antenna array composed of a plurality of antennas to improve directionality of the antenna array may include RF lenses for antenna provided in an upper portion of the antenna array to change a beam shape of each of the plurality of antennas—the RF lenses for antenna being disposed to respectively correspond to the plurality of antennas—and an RF lens for array provided in an upper portion of the RF lenses for antenna to refract a steering angle of a beam formed within a first angle range by the antenna array to change a steering angle range of the beam of the antenna array from the first angle range to a second angle range wider or narrower than the first angle range.

According to an aspect, the first angle range may be determined as a value satisfying a constraint by the changed beam shape of each of the plurality of antennas.

According to an exemplary embodiment, a beamforming method performed in a transmit and receive antenna system including an antenna array composed of a plurality of antennas, RF lenses for antenna provided in an upper portion of the antenna array—the RF lenses for antenna being disposed to respectively correspond to the plurality of antennas—, an RF lens for array provided in an upper portion of the RF lenses for antenna may include changing, by each of the RF lenses for antenna, a beam shape of each the plurality of antennas, forming, by the antenna array, a beam within a first angle range, and refracting, by the RF lens for array, a steering angle of the beam of the antenna array such that a steering angle range of the beam of the antenna array is changed from the first angle range to a second angle range wider or narrower than the first angle range.

According to an aspect, the forming of the beam within the first angle range may include determining the first angle range satisfying a constraint by the changed beam shape of each of the plurality of antennas.

According to another aspect, the changing of the beam shape of each of the plurality of antennas may include refracting rays forming a beam of each of the plurality of antennas to change the beam shape of each of the plurality of antennas within a specific angle range.

According to another aspect, the changing of the beam shape of each of the plurality of antennas within the specific angle range may include refracting rays of each of the plurality of antennas such that a gain of each of the plurality of antennas has a threshold within only the specific angle range.

### Advantageous Effects of the Invention

An embodiment may provide the technology capable of resolving the degradation of the steering performance of the antenna array, which occurs by non-linearity between a spatial frequency and an incident angle and directionality of the antenna and covering a wide angle using a single antenna array, in the transmit and receive antenna system having the multiple antennas.

In detail, an embodiment may provide the transmit and receive antenna system using an RF lens device including RF lenses for antenna disposed to respectively correspond to a plurality of antennas forming an antenna array and an RF lens for array provided in an upper portion of the RF lenses for antenna and the beamforming method.

### DESCRIPTION OF THE DRAWINGS

FIG. 1 is a drawing illustrating a conventional transmit and receive antenna system;

FIG. 2 is a drawing illustrating a relationship between a spatial frequency and an incident angle;

FIG. 3 is a drawing illustrating a gain characteristic and directionality according to an angle of an antenna, in a conventional structured ideal transmit and receive antenna system;

FIG. 4 is a drawing illustrating a gain of an antenna array according to an angle when steering the antenna array in the direction of 0°, in a conventional structured ideal transmit and receive antenna system;

FIG. 5 is a drawing illustrating a gain of an antenna array according to an angle when steering the antenna array in the direction of 30°, in a conventional structured ideal transmit and receive antenna system;

FIG. 6 is a drawing illustrating a gain of an antenna array according to an angle when steering the antenna array in the direction of 60°, in a conventional structured ideal transmit and receive antenna system;

FIG. 7 is a drawing illustrating a gain of an antenna array according to an angle when steering the antenna array in the direction of 90°, in a conventional structured ideal transmit and receive antenna system;

FIG. 8 is a drawing illustrating a gain characteristic and directionality according to an angle of an antenna, in a conventional structured realistic transmit and receive antenna system;

FIG. 9 is a drawing illustrating a gain of an antenna array according to an angle when steering the antenna array in the direction of 0°, in a conventional structured realistic transmit and receive antenna system;

FIG. 10 is a drawing illustrating a gain of an antenna array according to an angle when steering the antenna array in the direction of 30°, in a conventional structured realistic transmit and receive antenna system;

FIG. 11 is a drawing illustrating a gain of an antenna array according to an angle when steering the antenna array in the direction of 60°, in a conventional structured realistic transmit and receive antenna system;

FIG. 12 is a drawing illustrating a gain of an antenna array according to an angle when steering the antenna array in the direction of 90°, in a conventional structured realistic transmit and receive antenna system;

FIG. 13 is a drawing illustrating a transmit and receive antenna system according to an embodiment;

FIG. 14 is a drawing illustrating an RF lens for antenna included in the transmit and receive antenna system of FIG. 13;

FIG. 15 is a drawing illustrating a gain characteristic and directionality according to an angle of an antenna, in a transmit and receive antenna system according to an embodiment;

FIG. 16 is a drawing illustrating an embodiment of an RF lens for array included in the transmit and receive antenna system shown in FIG. 13;

FIG. 17 is a drawing illustrating another embodiment of an RF lens for array included in the transmit and receive antenna system shown in FIG. 13; and

FIG. 18 is a flowchart illustrating a beamforming method in a transmit and receive antenna system according to an embodiment,

### BEST MODE

Hereinafter, an embodiment of the inventive concept will be described in detail with reference to the accompanying drawings. However, the inventive concept is restricted or limited to embodiments of the inventive concept. Further, like reference numerals shown in each drawing indicates like members.

Further, the terminology used in the specification may be terms used to properly represent an exemplary embodiment of the inventive concept and may vary according to intention of a user or an operator or custom of a field included in the inventive concept. Therefore, the terminology will be defined based on contents across the specification.

Embodiments described in the specification relate to a transmit and receive antenna system having multiple antennas and constitutes the transmit and receive antenna system to include RF lenses for antenna, which are disposed to respectively correspond to a plurality of antennas forming an antenna array to change a beam shape of each of the plurality of antennas, and an RF lens for array, which is provided in an upper portion of the RF lenses for antenna to refract a steering angle of a beam formed within a first angle range by the antenna array to change a steering angle range of the beam of the antenna array from the first angle range to a second angle range wider or narrower than the first angle range, thus resolving degradation of the steering performance of the antenna array, which occurs by non-linearity between a spatial frequency and an incident angle and directionality of the antenna and covering a wide angle using the single antenna array.

Hereinafter, the transmit and receive antenna system having the multiple antennas refers to a system which includes an antenna array composed of a plurality of antennas as the multiple antennas to transmit and receive a signal. Furthermore, for convenience of description, the inventive concept is exemplified as, but not limited to, the receive beamforming technology in the transmit and receive antenna system and is also applicable to the MIMO transmission and reception technology as well as the transmit beamforming technology. Furthermore, hereinafter, the antenna array is described as, but not limited to, a one-dimensional linear array, and may be expanded and applied to a two-dimensional array.

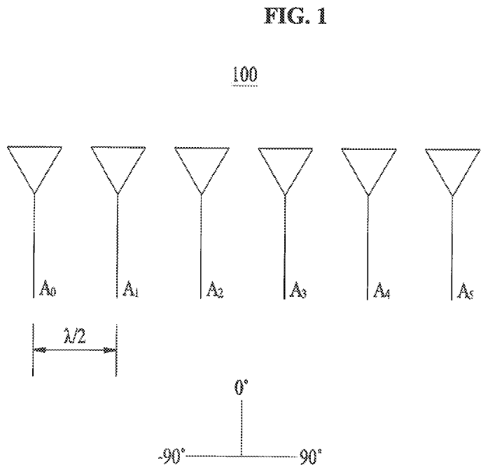

FIG. 1 is a drawing illustrating a conventional transmit and receive antenna system.

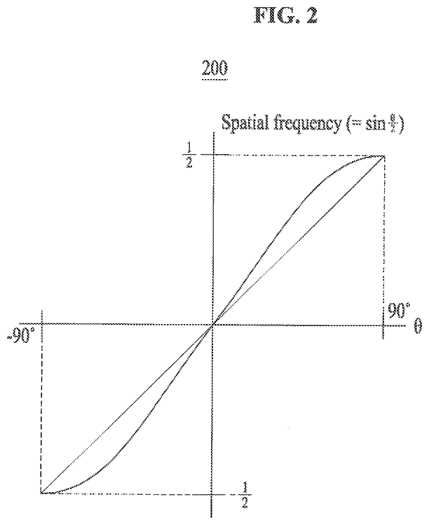

Referring to FIG. 1, the conventional transmit and receive antenna system may have a structure including a linear antenna array 100 composed of a plurality of antennas A₀, A₁, A₂, A₃, A₄, and A₅. At this time, it is assumed that an interval between the plurality of antennas A₀, A₁, A₂, A₃, A₄, and A₅ in the linear antenna array 100 is, but is not limited to, half a wavelength λ/2. Hereinafter, an ideal transmit and receive antenna system and a realistic transmit and receive antenna system described below with reference to FIGS. 2 to 12 are subject to having the structure shown in FIG. 1.

FIG. 2 is a drawing illustrating a relationship between a spatial frequency and an incident angle.

When a signal is received in a linear antenna array in the conventional structured transmit and receive antenna system described above with reference to FIG. 1, the signal received in each of a plurality of antennas forming the linear antenna array may have a different phase value depending on an incident angle. A phase change rate according to the space may be a spatial frequency, and the spatial frequency may have a non-linear relationship with an incident angle of the signal as shown in graph 200 of FIG. 2.

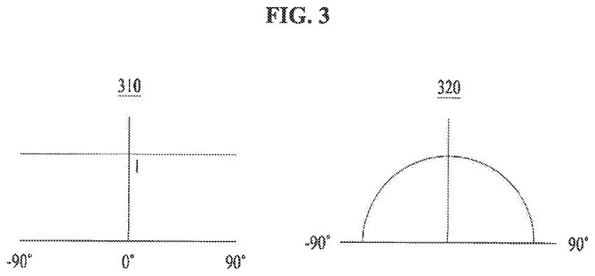

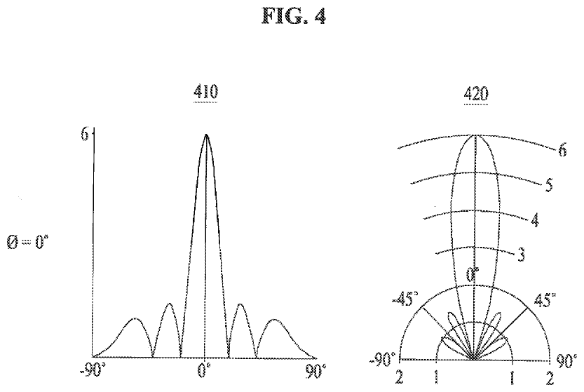

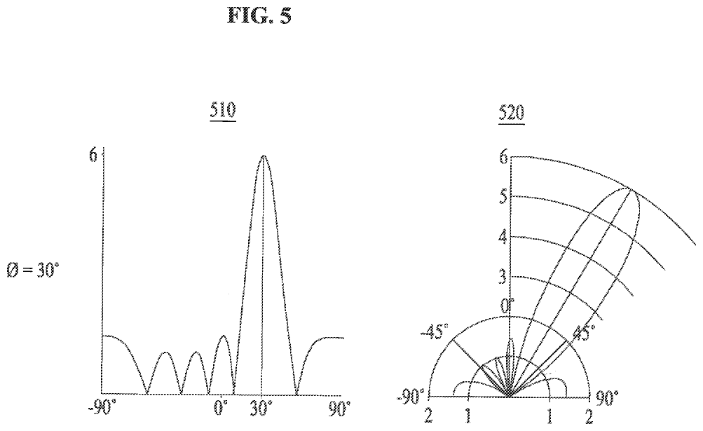

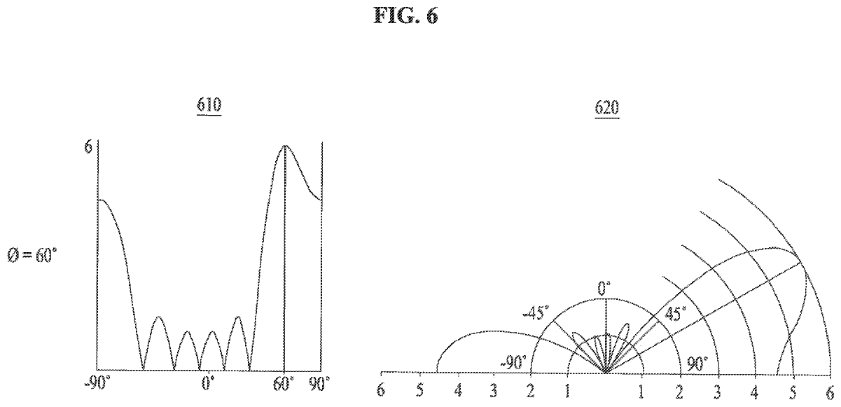

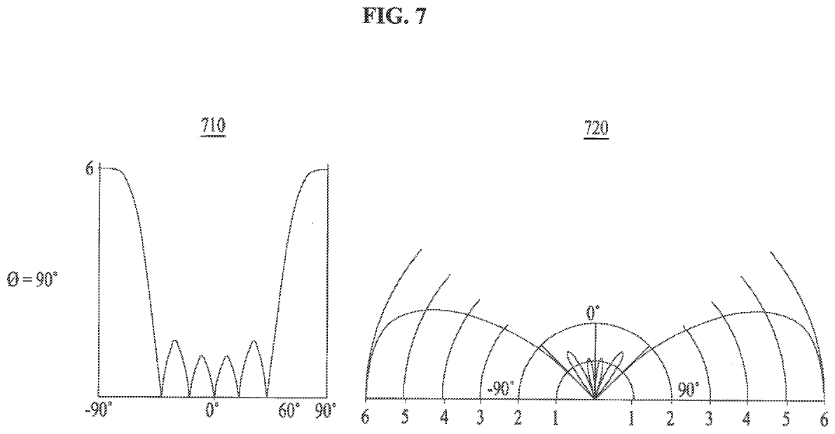

FIG. 3 is a drawing illustrating a gain characteristic and directionality according to an angle of an antenna, in a conventional structured ideal transmit and receive antenna system. FIG. 4 is a drawing illustrating a gain of an antenna array according to an angle when steering the antenna array in the direction of 0°, in a conventional structured ideal transmit and receive antenna system. FIG. 5 is a drawing illustrating a gain of an antenna array according to an angle when steering the antenna array in the direction of 30°, in a conventional structured ideal transmit and receive antenna system. FIG. 6 is a drawing illustrating a gain of an antenna array according to an angle when steering the antenna array in the direction of 60°, in a conventional structured ideal transmit and receive antenna system. FIG. 7 is a drawing illustrating a gain of an antenna array according to an angle when steering the antenna array in the direction of 90°, in a conventional structured ideal transmit and receive antenna system.

Referring to FIG. 3, when a gain according to an angle of an antenna in a conventional structured transmit and receive antenna system, that is, a beam pattern has a characteristic where it is always 1 in a direction range of −90° to 90° as shown in 310, when representing the beam pattern on a Cartesian coordinate system, 310 is indicated as 320 when graphing 310 on a polar coordinate system. As such, when the linear antenna array steers in a specific direction in a transmit and receive antenna system (a conventional structured transmit and receive antenna system) of an ideal case, a gain of the antenna array according to an angle, that is, a beam pattern may be represented as shown in FIGS. 4 to 7.

Hereinafter, the beam pattern may refer to a radiation pattern of an antenna or a radiation pattern of an antenna array composed of multiple antennas. Directionality may refer to a degree or properties where the beam pattern of the antenna or the antenna array is concentrated on a specific direction. For example, directionality capable of being represented as a beam shape may be used as an expression such as being high, large, or low. At this time, when the directionality is high, the beam shape may be narrow. When the directionality is low, the beam shape may be narrow. Hereinafter, the beam shape may be the concept of including a beam width, and “changing the beam shape” may refer to removing energy radiation except for a certain angle range to maintain an antenna gain within the certain angle range at the same that the beam width is located within the certain angle range.

Furthermore, steering may mean that a steering angle of a directional antenna or a directional antenna array is directed in a desired direction.

Referring to FIG. 4, in an ideal transmit and receive antenna system, when an antenna array steers in the direction of 0°, a gain of the antenna array according to an angle, that is, a beam pattern may be represented as 410 when graphing the beam pattern using a linear scale on the Cartesian coordinate system, and the beam pattern 410 may be represented as 420 when graphing the beam pattern using a linear scale on the polar coordinate system.

At this time, as the number of antennas forming the antenna array is higher, the beam pattern of the antenna array may be more increased in directionality and may be more sharply formed. However, although there are a same number of antennas, a beam pattern when an array steers in the direction of 0° may have the highest directionality. As a steering angle goes in the direction of 90° or −90°, the directionality of the beam pattern may be degraded. Such a problem may occur because a relationship between an incident angle and a spatial frequency of the signal is a non-linear relationship as shown in FIG. 2.

Hereinafter, the steering angle may refer to an angle or direction where energy radiation of an antenna having directionality or an antenna array having directionality is concentrated. At this time, the steering angle may have the same meaning as the direction of a beam.

Referring to FIG. 5, in an ideal transmit and receive antenna system, when an antenna array steers in the direction of 30°, a gain of the antenna array according to an angle, that is, a beam pattern may be represented as 510 when graphing the beam pattern using a linear scale on the Cartesian coordinate system, and the beam pattern 510 may be represented as 520 when graphing the beam pattern using a linear scale on the polar coordinate system.

Herein, it may be verified that the beam pattern when the antenna array steers in the direction of 30° is a little reduced in directionality compared to the beam pattern described above with reference to FIG. 4, but maintains relatively good directionality.

Referring to FIG. 6, in an ideal transmit and receive antenna system, when an antenna array steers in the direction of 60°, a gain of the antenna array according to an angle, that is, a beam pattern may be represented as 610 when graphing the beam pattern using a linear scale on the Cartesian coordinate system, and the beam pattern 610 may be represented as 620 when graphing the beam pattern using a linear scale on the polar coordinate system.

At this time, because a beam pattern when the antenna array steers in the direction of 60° is dearly reduced in directionality compared to the beam pattern described above with reference to FIG. 4 and the beam pattern described above with reference to FIG. 5 and because a gain of the antenna array for the direction of −90° is greater than or equal to 4.5, there is a problem where interference by a signal from the direction of −90°, which is an undesired direction, may greatly occur.

Referring to FIG. 7, in an ideal transmit and receive antenna system, when an antenna array steers in the direction of 90°, a gain of the antenna array according to an angle, that is, a beam pattern may be represented as 710 when graphing the beam pattern using a linear scale on the Cartesian coordinate system, and the beam pattern 710 may be represented as 720 when graphing the beam pattern using a linear scale on the polar coordinate system.

Herein, it is verified that the beam pattern when the antenna array steers in the direction of 90° is greatly reduced in directionality. There is a problem where a signal received from the direction of 90° is not distinguished from a signal received from the direction of −90°.

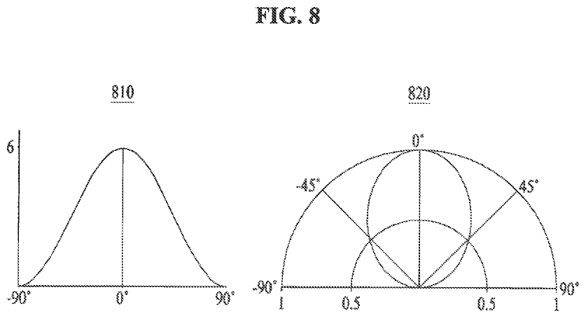

As above, the description is given of the transmit and receive antenna system of the ideal case having a characteristic where the gain according to the steering angle of the antenna is always 1 in the direction range of −90° to 90°, but, as a gain characteristic of the antenna itself also has directionality in a real wireless transmission and reception environment, a gain and directionality according to an angle of the antenna are represented differently from those in FIG. 3. A detailed description thereof will be described with reference to FIG. 8.

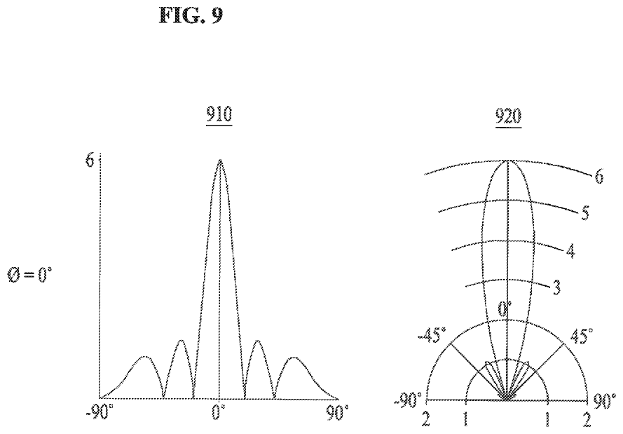

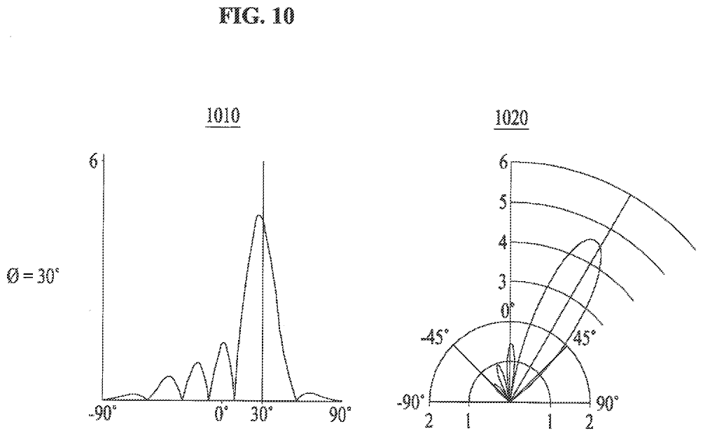

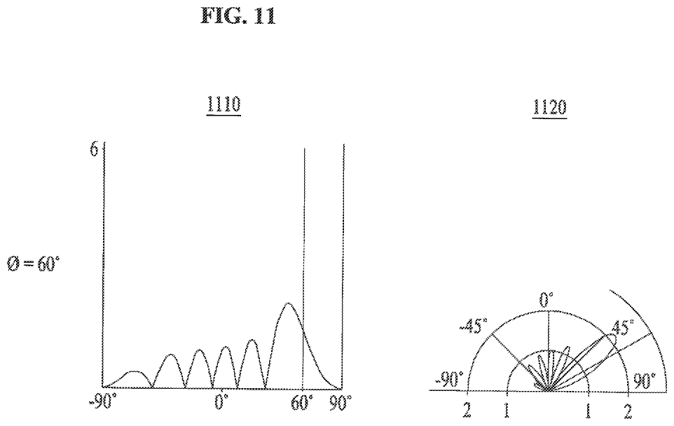

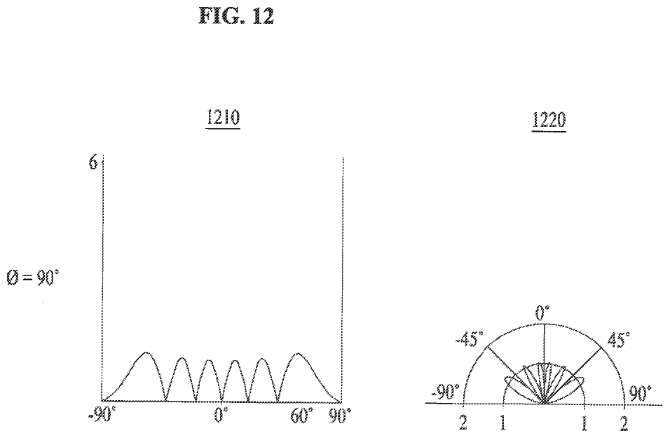

FIG. 8 is a drawing illustrating a gain characteristic and directionality according to an angle of an antenna, in a conventional structured realistic transmit and receive antenna system. FIG. 9 is a drawing illustrating a gain of an antenna array according to an angle when steering the antenna array in the direction of 0°, in a conventional structured realistic transmit and receive antenna system. FIG. 10 is a drawing illustrating a gain of an antenna array according to an angle when steering the antenna array in the direction of 30°, in a conventional structured realistic transmit and receive antenna system. FIG. 11 is a drawing illustrating a gain of an antenna array according to an angle when steering the antenna array in the direction of 60°, in a conventional structured realistic transmit and receive antenna system. FIG. 12 is a drawing illustrating a gain of an antenna array according to an angle when steering the antenna array in the direction of 90°, in a conventional structured realistic transmit and receive antenna system.

Referring to FIG. 8, when a conventional structured transmit and receive antenna system has a characteristic in which, when indicating a gain according to a steering angle of an antenna, that is, a beam pattern on a Cartesian coordinate system, the gain is 1 with respect to the direction of 0° as shown in 810 and is gradually reduced as the angle is moved in the direction of −90° or 90°, 810 may be represented as 820 when graphing 810 on a polar coordinate system. As such, in a transmit and receive antenna system (a conventional structured transmit and receive antenna system) of a realistic case, when the linear antenna array steers in a specific direction, a gain of the antenna array according to an angle, that is, a beam pattern may be represented as shown in FIGS. 9 to 12.

Referring to FIG. 9, in a realistic transmit and receive antenna system, when an antenna array steers in the direction of 0°, a gain of the antenna array according to an angle, that is, a beam pattern may be represented as 910 when graphing the beam pattern using a linear scale on the Cartesian coordinate system, and the beam pattern 910 may be represented as 920 when graphing the beam pattern using a linear scale on the polar coordinate system.

At this time, it is verified that a beam pattern of the antenna array such as 920 has higher directionality than the beam pattern described above with reference to FIG. 4. This is because a steering angle of the antenna itself is identical to a steering angle of the antenna array.

Referring to FIG. 10, in a realistic transmit and receive antenna system, when an antenna array steers in the direction of 30°, a gain of the antenna array according to an angle, that is, a beam pattern may be represented as 1010 when graphing the beam pattern using a linear scale on the Cartesian coordinate system, and the beam pattern 1010 may be represented as 1020 when graphing the beam pattern using a linear scale on the polar coordinate system.

Herein, it is verified that a gain of the antenna array when steering in the direction of 30° tends to move a lithe more to the left than the gain of the antenna array described above with reference to FIG. 5. That is, when a steering angle of the antenna itself is not identical to a steering angle of an antenna array when there is directionality of the antenna itself like a realistic transmit and receive antenna system, it may have a bad effect on adjusting a steering direction of the antenna array.

Referring to FIG. 11, in a realistic transmit and receive antenna system, when an antenna array steers in the direction of 60°, a gain of the antenna array according to an angle, that is, a beam pattern may be represented as 1110 when graphing the beam pattern using a linear scale on the Cartesian coordinate system, and the beam pattern 1110 may be represented as 1120 when graphing the beam pattern using a linear scale on the polar coordinate system.

At this time, it is verified that a beam pattern when the antenna array steers in the direction of 60° is not incorrectly formed by directionality of the antenna itself.

Referring to FIG. 12, in a realistic transmit and receive antenna system, when an antenna array steers in the direction of 90°, a gain of the antenna array according to an angle, that is, a beam pattern may be represented as 1210 when graphing the beam pattern using a linear scale on the Cartesian coordinate system, and the beam pattern 1210 may be represented as 1220 when graphing the beam pattern using a linear scale on the polar coordinate system.

As such, when beamforming is performed in the realistic transmit and receive antenna system, due to directionality of the antenna itself, when a beam steering angle of the antenna array is increased, there may occur a problem where beamforming performance is severely degraded. Furthermore, because a conventional structured transmit and receive antenna system does not resolve the problem, there is a disadvantage where a steering angle of a beam pattern of the antenna array is limited to a much narrower angle range than 120°.

However, a sector antenna in mobile communication frequently should cover 120°, and a short-range radar for an autonomous vehicle, in which research has been actively conducted recently, should cover about 120°. However, as described with reference to FIGS. 8 to 12, it is impossible for the conventional structured transmit and receive antenna system to cover 120° using a single antenna array.

Thus, embodiments below proposes a transmit and receive antenna system capable of resolving degradation of the steering performance of the antenna array and covering a wide angle using a single antenna array by including an RF lens device.

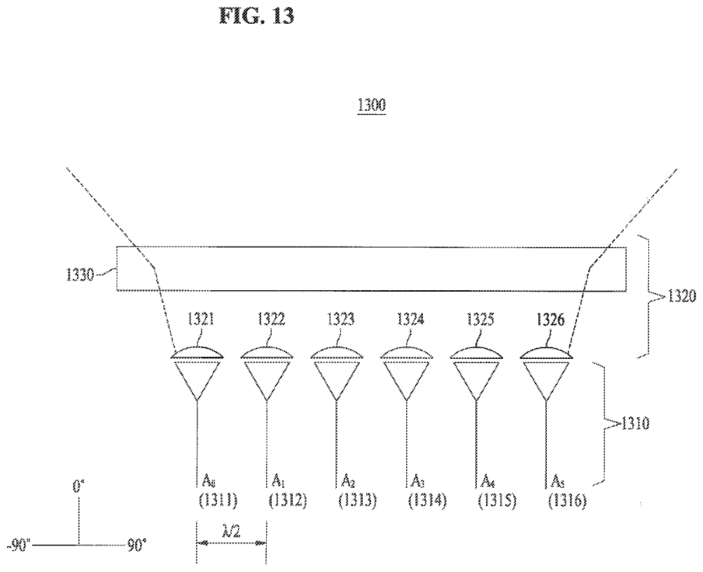

FIG. 13 is a drawing illustrating a transmit and receive antenna system according to an embodiment.

Referring to 13, a transmit and receive antenna system 1300 according to an embodiment may include an antenna array 1310 composed of a plurality of antennas 1311, 1312, 1313, 1314, 1315, and 1316 and an RF lens device 1320. Hereinafter, it is assumed that an interval between the plurality of antennas 1311, 1312, 1313, 1314, 1315, and 1316 is half a wavelength λ/2 of a carrier frequency in the antenna array 1310, but not restricted or limited thereto, Furthermore, the antenna array 1310 is described as, but not restricted or limited to, a one-dimensional linear array as shown and may be a two-dimensional array where the plurality of antennas 1311, 1312, 1313, 1314, 1315, and 1316 are arranged in two dimensions. In such a case, the RF lens device 1320 described below is applicable in the same manner.

The RF lens device 1320 may include RF lenses 1321, 1322, 1323, 1324, 1325, and 1326 for antenna, which are provided in an upper portion of the antenna array 1310 and are disposed to respectively correspond to the plurality of antennas 1311, 1312, 1313, 1314, 1315, and 1316, and an RF lens 1330 for array, which is provided in an upper portion of the RF lenses 1321, 1322, 1323, 1324, 1325, and 1326 for antenna.

Herein, the RF lenses 1321, 1322, 1323, 1324, 1325, and 1326 for antenna may be disposed to respectively correspond one to one with the plurality of antennas 1311, 1312, 1313, 1314, 1315, and 1316. For example, the RF lens 1321 for antenna A₀ may be disposed in an upper portion of antenna A₀ 1311, and the RF lens 1322 for antenna A₁ may be disposed in an upper portion of antenna A₁ 1312. Similarly, the RF lenses 1323, 1324, 1325, and 1326 for the other antennas may be disposed to respectively correspond one to one to the other antennas 1313, 1314, 1315, and 1316.

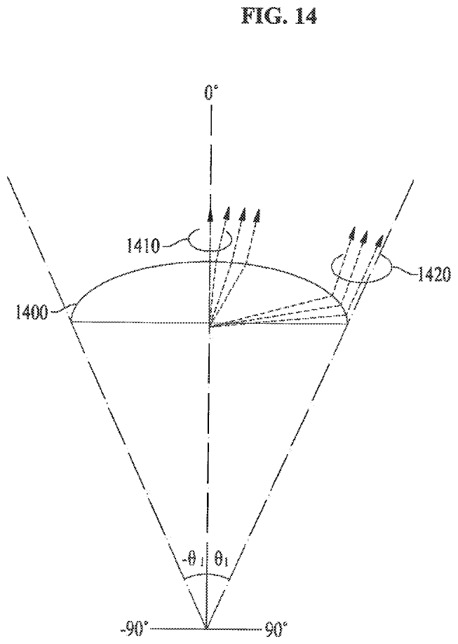

Each of the RF lenses 1321, 1322, 1323, 1324, 1325, and 1326 for antenna may change a beam shape of each of the plurality of antennas 1311, 1312, 1313, 1314, 1315, and 1316. For example, the RF lens 1321 for antenna A₀ may change a beam shape of antenna A₀ 1311 to −θ₁ to θ₁, the RF lens 1322 for antenna A₁ may change a beam shape of antenna A₁ 1312 to −θ₁ to θ₁, the RF lens 1323 for antenna A₂ may change a beam shape of antenna A₂ 1313 to −θ₁ to θ₁, the RF lens 1324 for antenna A₃ may change a beam shape of antenna A₃ 1314 to −θ₁ to θ₁, the RF lens 1325 for antenna A₄ may change a beam shape of antenna A₄ 1315 to −θ₁ to θ₁, and the RF lens 1326 for antenna A₅ may change a beam shape of antenna A₅ 1316 to −θ₁ to θ₁. Hereinafter, 2*θ₁ may be an amount indicating a beam shape (width) of an antenna beam pattern changed by the RF lenses 1321, 1322, 1323, 1324, 1325, and 1326 for antenna, and θ₁ may refers to a parameter associated with the changed antenna beam pattern. A detailed description thereof will be described with reference to FIG. 14.

At this time, that each of the RF lenses 1321, 1322, 1323, 1324, 1325, and 1326 for antenna changes the beam shape of each of the plurality of antennas 1311, 1312, 1313, 1314, 1315, and 1316 may refer to changing directionality of each of the plurality of antennas 1311, 1312, 1313, 1314, 1315, and 1316 (directionality of the antenna itself). Thus, each of the RF lenses 1321, 1322, 1323, 1324, 1325, and 1326 for antenna may be designed with respect to directionality of each itself of the plurality of antennas 1311, 1312, 1313, 1314, 1315, and 1316 (e.g., an aspheric lens or the like may be used and one or more lens elements may be used).

The antenna array 1310 may form a beam within a first angle range. At this time, the antenna array 1310 may determine the first angle range satisfying a constraint by the beam shape of each of the plurality of antennas 1311, 1312, 1313, 1314, 1315, and 1316, which is changed by each of the RF lenses 1321, 1322, 1323, 1324, 1325, and 1326 for antenna, thus forming a beam within the determined first angle range. For example, the antenna array 1310 may determine a value of −φ₁ to φ₁ which is the first angle range, such that −φ₁ to φ₁ which is the first angle range is located within −θ₁ to θ₁ which is the changed beam shape of each of the plurality of antennas 1311, 1312, 1313, 1314, 1315, and 1316. In detail, in determining parameter φ₁ of the first angle range forming a beam, the antenna array 1310 may use a formula of φ₁=θ₁−(beam width of the antenna array 1310)/2 as a constraint by parameter θ₁ of the changed beam shape of each of the plurality of antennas 1311, 1312, 1313, 1314, 1315, and 1316. Hereinafter, −φ₁ to φ₁ which is the first angle range may refer to a value indicating a steering angle range of a beam of the antenna array 1310.

The RF lens 1330 for array may refract a steering angle of a beam of the antenna array 1310 such that a steering angle range of the beam of the antenna array 1310 is changed from the first angle range to a second angle range wider or narrower than the first angle range. In other words, the RF lens 1330 for array may change the steering angle range of the beam of the antenna array 1310 from the first angle range to the second angle range.

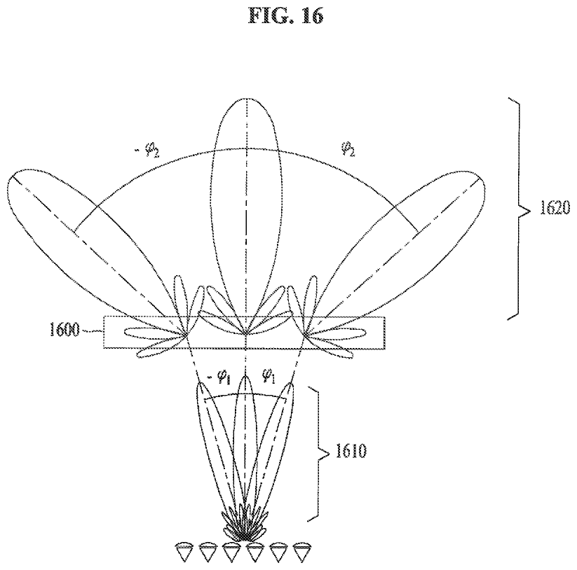

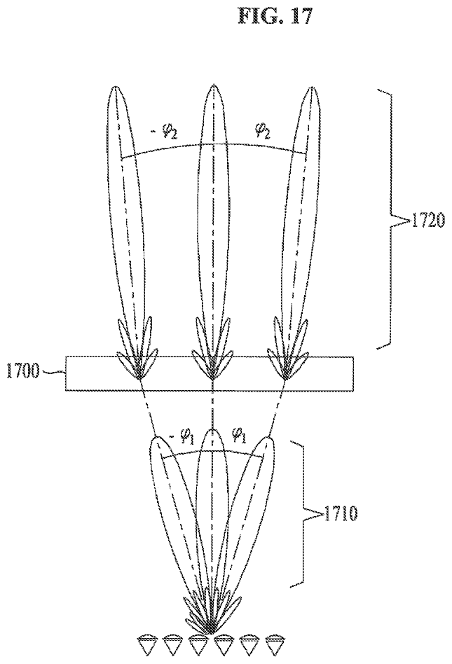

For example, the RF lens 1330 for array may refract a steering angle of the beam of the antenna array 1310 having the first angle range of −φ₁ to φ₁, such that the beam of the antenna array 1310 has the second angle range of −φ₂ to φ₂. Thus, the RF lens 1330 for array may refract the steering angle of the beam of the antenna array 1310, thus narrowing or widening a coverage of the antenna array 1310. Hereinafter, −φ₂ to φ₂ which is the second angle range may refer to a value indicating a range of a steering angle changed by the refraction after the beam of the antenna array 1310 passes through the RF lens 1330 for array. A detailed description thereof will be described with reference to FIGS. 16 and 17.

As such, the transmit and receive antenna system 1300 according to an embodiment may include the RF lenses 1321, 1322, 1323, 1324, 1325, and 1326 for antenna for changing a beam shape of each of the plurality of antennas 1311, 1312, 1313, 1314, 1315, and 1316 and the RF lens 1330 for array for refracting a steering angle of a beam formed within the first angel range by the antenna array 1310 to change the steering angle range of the beam of the antenna array 1310 from the first angle range to the second angle range, thus resolving degradation of the steering performance of the antenna array, which is generated by non-linearity between a spatial frequency and an incident angle and directionality of the antenna, and covering a wide angle using the single antenna array.

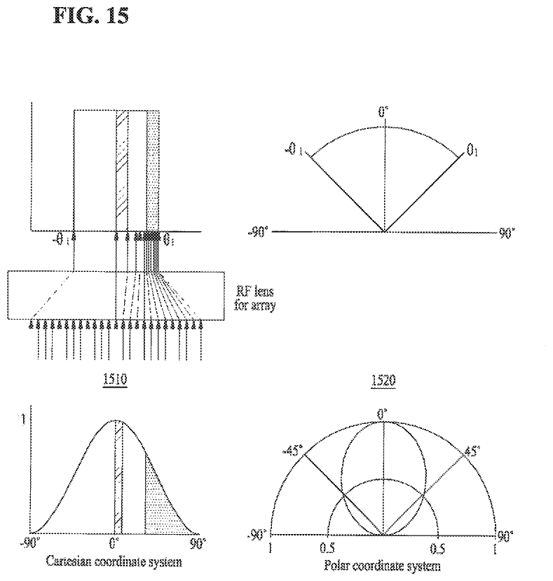

FIG. 14 is a drawing illustrating an RF lens for antenna included in the transmit and receive antenna system of FIG. 13. FIG. 15 is a drawing illustrating a gain characteristic and directionality according to an angle of an antenna, in a transmit and receive antenna system according to an embodiment. Hereinafter, an RF lens 1400 for antenna described with reference to FIG. 14 indicates each of RF lenses for antenna included in the transmit and receive antenna system described above with reference to FIG. 13.

Referring to FIG. 14, an RF lens 1400 for antenna may have a characteristic shown in FIG. 15 in directionality of an antenna in a real wireless transmission and reception environment. In detail, the RF lens 1400 for antenna may refract rays forming a beam of an antenna to change a beam shape of the antenna within a specific angle range (e.g., −θ₁ to θ₁).

For example, the RF lens 1400 for antenna may disperse rays 1410 in the direction of being close to 0° among rays forming the beam of the antenna through refraction to reduce an antenna gain and may concentrate rays 1420 in the direction of being close to 90° among the rays forming the beam of the antenna through refraction, thus changing a beam shape of the antenna within −θ₁ to θ₁ such that the antenna gain has a threshold within only a specific angle range (−θ₁ to θ₁),

FIG. 15 illustrates the beam pattern of the antenna, which is changed as a result of describing the process of FIG. 14, where the beam shape of the antenna is changed as rays emitted from the antenna are refracted by the RF lens 1400 for antenna, in another method. In such a case, a gain of an antenna may always have a constant threshold irrespective of a direction within −θ₁ to θ₁like 1510 and may show a characteristic having a value of 0 with respect to the direction of less than −θ₁ or the direction of greater than θ₁. When graphing 1510 on the polar coordinate system, it may be represented as 1520. Thus, the RF lens 1400 for antenna may prevent interference from an undesired direction in the antenna.

A specific angle range of −θ₁ to θ₁ where the beam shape of the antenna, which is described above, is changed (an angle range covered by a beam of the beam pattern of the antenna) may have an influence on a constraint of determining an angle range (a first angle range) where an antenna array, included in a transmit and receive antenna system (the transmit and receive antenna system described with reference to FIG. 13) to which a structure and an operation of the above-mentioned RF lens 1400 for antenna are applied, wants to form a beam.

Thus, the RF lens 1400 for antenna may be provided to be able to control a lens focal length (be implemented to have a zooming function) to adaptively adjust the specific angle range. The transmit and receive antenna system to which the RF lens 1400 for antenna is applied may adaptively adjust the first angle range where the beam of the antenna array is formed, depending on a constraint by the adjusted beam shape of each of the plurality of antennas.

FIG. 16 is a drawing illustrating an embodiment of an RF lens for array included in the transmit and receive antenna system of FIG. 13.

Referring to FIG. 16, in the situation of φ₁<θ₁<φ₂, an RF lens 1600 for array included in the transmit and receive antenna system described with reference to FIG. 13 may refract a steering angle of a beam 1610 of an antenna array having a steering angle range of −φ₁ to φ₁ which is a first angle range, such that a beam 1620 of the antenna array has a steering angle range of −φ₂ to φ₂ which is a second angle range wider than −φ₁ to φ₁. Thus, a steering angle of the beam 1610 of the antenna array before passing through the RF lens 1600 for array is included in −θ₁ to θ₁, but a steering angle of the beam 1620 of the antenna array after passing through the RF lens 1600 for array may cover an angle range wider than −θ₁ to θ₁ and may prevent the occurrence of a problem of the degradation of steering performance, which occurs in existing beamforming.

Such an operation of the RF lens 1600 for array may be performed as the RF lens 1600 for array controls a lens focal length to be short. In other words, the RF lens 1600 for array may be provided to be able to control a lens focal length (be implemented to have a zooming function) to adaptively adjust a second angle range to which a first angle range is changed.

FIG. 17 is a drawing illustrating another embodiment of an RF lens for array included in the transmit and receive antenna system of FIG. 13.

Referring to FIG. 17, in the situation of φ₁<θ₁<φ₂, an RF lens 1700 for array included in the transmit and receive antenna system described with reference to FIG. 13 may refract a steering angle of a beam 1710 of an antenna array having a steering angle range of −φ₁ to φ₁ which is a first angle range, such that a beam 1720 of the antenna array has a steering angle range of −φ₂ to φ₂ which is a second angle range narrower than −φ₁ to φ₁. Thus, as the beam 1720 of the antenna array after passing through the RF lens 1700 for array becomes sharper than the beam 1710 of the antenna array before passing through the RF lens 1700 for array, more sophisticated steering of the beam facilitates using higher spatial resolution. Such a characteristic may be indicated as an increase in cell capacity in mobile communication and may be indicated as improved spatial resolution for target recognition in a radar system.

Such an operation of the RF lens 1700 for array may be performed as the RF lens 1700 for array controls a lens focal length to be long. In other words, the RF lens 1700 for array may be provided to be able to control a lens focal length (be implemented to have a zooming function) to adaptively adjust the second angle range to which the first angle range is changed.

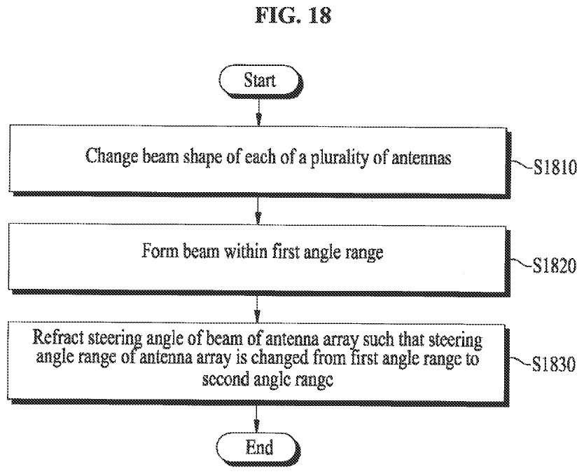

FIG. 18 is a flowchart illustrating a beamforming method in a transmit and receive antenna system according to an embodiment.

Referring to FIG. 18, the beamforming method according to an embodiment may be performed by means of the transmit and receive antenna system (particularly, the RF lens device) described above with reference to FIGS. 13 to 17.

In step S1810, each of RF lenses for antenna included in the RF lens device may change a beam shape of each of a plurality of antennas.

In detail, in step S1810, each of the RF lenses for antenna may refract rays forming a beam of each of the plurality of antennas to change a beam shape of each of the plurality of antennas within a specific angle range.

Furthermore, each of the RF lenses for antenna may be provided to be able to control a lens focal length to adaptively adjust the specific angle range.

At this time, changing the beam shape of each of the plurality of antennas within the specific angle range may refer to refracting rays of each of the plurality of antennas such that a gain of each of the plurality of antennas has a threshold within only the specific angle range

Subsequently, in step S1820, an antenna array in which the RF lens device is provided may form a beam within a first angle range. Particularly, the antenna array may determine the first angle range satisfying a constraint by the changed beam shape of each of the plurality of antennas and may form a beam within the determined first angle range. For example, when the beam shape of each of the plurality of antennas is changed to −θ₁ to θ₁ in step S1810, in step 1820, the antenna array may determine the first angle range as −φ₁˜φ₁ satisfying the constraint of φ₁<θ₁ and may form a beam within the first angle range of −φ₁˜φ₁.

Thereafter, in step 1830, an RF lens for array included in the RF lens device may refract a steering angle of the beam of the antenna array such that the steering angle range of the beam of the antenna array is changed from the first angle range to a second angle range wider or narrower than the first angle range.

In other words, in step 1830, the RF lens for array may change the steering angle of the beam of the antenna array from the first angle range to the second angle range.

As above, the beamforming method is described as including, but not restricted or limited to, the three steps S1810 to S1830, and may additionally further include other steps.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. A transmit and receive antenna system for improving antenna directionality, the system comprising:
an antenna array composed of a plurality of antennas;
RF lenses for antenna provided in an upper portion of the antenna array—the RF lenses for antenna being disposed to respectively correspond to the plurality of antennas—; and
an RF lens for array provided in an upper portion of the RF lenses for array.

2. The system of claim 1, wherein each of the RF lenses for antenna changes a beam shape of each of the plurality of antennas,
wherein the antenna array forms a beam within a first angle range, and
wherein the RF lens for array refracts a steering angle of the beam of the antenna array such that a steering angle range of the beam of the antenna array is changed from the first angle range to a second angle range wider or narrower than the first angle range.

3. The system of claim 2, wherein the antenna array determines the first angle range satisfying a constraint by the changed beam shape of each of the plurality of antennas.

4. The system of claim 2 wherein each of the RF lenses for antenna refracts rays forming a beam of each of the plurality of antennas to change the beam shape of each of the plurality of antennas within a specific angle range.

5. The system of claim 4, wherein each of the RF lenses for antenna is provided to be able to control a lens focal length to adaptively adjust the specific angle range.

6. The system of claim 4, wherein each of the RF lenses for antenna refracts rays of each of the plurality of antennas such that a gain of each of the plurality of antennas has a threshold within only the specific angle range.

7. The system of claim 2, wherein the RF lenses for antenna are disposed to respectively correspond one to one with the plurality of antennas.

8. The system of claim 2, wherein the RF lens for array is provided to be able to control a lens focal length to adaptively adjust the second angle range.

9. An RF lens device provided in an upper portion of an antenna array composed of a plurality of antennas to improve directionality of the antenna array, the RF lens device comprising:
RF lenses for antenna provided in an upper portion of the antenna array to change a beam shape of each of the plurality of antennas—the RF lenses for antenna being disposed to respectively correspond to the plurality of antennas—; and
an RF lens for array provided in an upper portion of the RF lenses for antenna to refract a steering angle of a beam formed within a first angle range by the antenna array to change a steering angle range of the beam of the antenna array from the first angle range to a second angle range wider or narrower than the first angle range.

10. The RF lens device of claim 9, wherein the first angle range is determined as a value satisfying a constraint by the changed beam shape of each of the plurality of antennas.

11. A beamforming method performed in a transmit and receive antenna system including an antenna array composed of a plurality of antennas; RF lenses for antenna provided in an upper portion of the antenna array—the RF lenses for antenna being disposed to respectively correspond to the plurality of antennas—; and an RF lens for array provided in an upper portion of the RF lenses for antenna, the beamforming method comprising:
changing, by each of the RF lenses for antenna, a beam shape of each the plurality of antennas;
forming, by the antenna array, a beam within a first angle range; and
refracting, by the RF lens for array, a steering angle of the beam of the antenna array such that a steering angle range of the beam of the antenna array is changed from the first angle range to a second angle range wider or narrower than the first angle range.

12. The beamforming method of claim 11, wherein the forming of the beam within the first angle range includes;
determining the first angle range satisfying a constraint by the changed beam shape of each of the plurality of antennas.

13. The beamforming method of claim 11, wherein the changing of the beam shape of each of the plurality of antennas includes:
refracting rays forming a beam of each of the plurality of antennas to change the beam shape of each of the plurality of antennas within a specific angle range.

14. The beamforming method of claim 13, wherein the changing of the beam shape of each of the plurality of antennas within the specific angle range includes:
refracting rays of each of the plurality of antennas such that a gain of each of the plurality of antennas has a threshold within only the specific angle range.
